(19) United States
(12) Patent Application Publication
(10) Pub. No.: US 2012/0054729 A1
(43) Pub. Date: Mar. 1, 2012

(54) Safely Updating Latent Applications to Reduce Attack Surface

(75) Inventors: William E. Sobel, Stevenson Ranch, CA (US); Sourabh Satish, Fremont, CA (US)

(73) Assignee: SYMANTEC CORPORATION, Mountain View, CA (US)

(21) Appl. No.: 12/872,974

(22) Filed: Aug. 31, 2010

(51) Int. Cl. G06F 9/44

(52) U.S. Cl. 717/169

(57) ABSTRACT

Executable content on an endpoint is selectively patched based on the usage of the content. The usage of executable content on an endpoint is monitored. Based on the usage of the executable content, a usage score is calculated. The usage score indicates how often the executable content is used at the endpoint. Responsive to the usage score, a determination of whether to perform a patching action is made. If it is determined that a patching action is to be performed, a patching action is performed for the executable content.

### BACKGROUND OF THE INVENTION

1. Field of the Invention

This invention pertains in general to computer security and in particular to selectively patching executable content.

2. Description of the Related Art

Today the attack surface on many computer endpoints has migrated from the operating system itself to applications running on the operating systems. Some applications can be launched without the users directly invoking the applications, thus exposing any vulnerabilities in the applications to attack without the users even knowing that the applications are executing. For example, some applications designed to support web browsing can be launched if a user visits a malicious webpage.

Vendors often quickly release patches to address newly-discovered exploits of their applications. However, these patches may have the unintended consequence of breaking the application or interfering with other applications on the endpoints. As a result, it is not always appropriate to apply these patches to instances of the software residing on endpoints. For example, information technology (IT) administrators at large enterprises are often hesitant to apply the patches, fearing that the patches may interfere with the stability of the enterprises' endpoints. IT administrators are unwilling to take the risk of breaking critical enterprise systems, and, therefore, often roll out security patches only after the patches are extensively tested. The endpoints having the vulnerable applications are thus susceptible to attack until the patches are deployed.

### BRIEF SUMMARY OF THE INVENTION

The above and other needs are met by a method, a non-transitory computer-readable storage medium, and a system for selectively patching executable content on an endpoint. Embodiments of the method comprise monitoring the usage of the executable content on the endpoint. A usage score is calculated for the executable content. The usage score indicates how often the executable content is used at the endpoint. Responsive to the usage score, it is determined whether to perform a patching action on the executable content. A patching action is selectively performed based on the determination of whether to perform the patching action.

Embodiments of the computer-readable storage medium store computer-executable instructions for performing the steps described above. Embodiments of the system further comprise a processor for executing the computer-executable instructions.

The features and advantages described in this disclosure and in the following detailed description are not all-inclusive, and particularly, many additional features and advantages will be apparent to one of ordinary skill in the relevant art in view of the drawings, specification, and claims hereof. Moreover, it should be noted that the language used in the specification has been principally selected for readability and instructional purposes, and may not have been selected to delineate or circumscribe the inventive subject matter, resort to the claims being necessary to determine such inventive subject matter.

### BRIEF DESCRIPTION OF THE DRAWINGS

FIG. 1 is a high-level block diagram of a computing environment according to one embodiment.

FIG. 2 is a high-level block diagram illustrating a functional view of a typical computer system for use as an endpoint or security server according to one embodiment.

FIG. 3 is a high-level block diagram illustrating a detailed view of a selective patching module according to one embodiment.

FIG. 4 is a flowchart illustrating steps performed by the selective patching module according to one embodiment.

The figures depict various embodiment of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

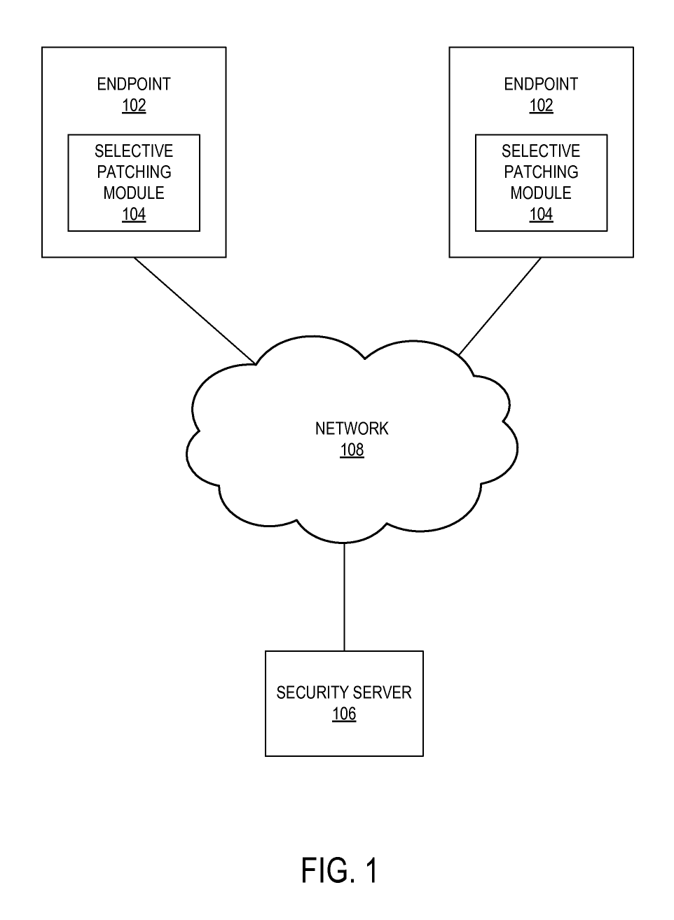

FIG. 1 is a high-level block diagram of a computing environment 100 according to one embodiment. FIG. 1 illustrates two endpoints 102 and a security server 106 connected by a network 108. Only two endpoints 102 are shown in FIG. 1 in order to simplify and clarify the description. Embodiments of the computing environment 100 can have thousands or millions of endpoints 102 connected to the network 108. Embodiments can have multiple security servers 106 as well.

In one embodiment, an endpoint 102 is a computer capable of running executable content. For example, the endpoint 102 can be a desktop, notebook, or server computer running an operating system such as MICROSOFT WINDOWS or APPLE OS X. In other embodiments, the endpoint 102 is a network-capable device other than a computer, such as a personal digital assistant (PDA), a mobile telephone, a pager, a television “set-top box,” etc.

The term “executable content” refers to any computer program code that can be installed and executed on the endpoint 102. As such, the executable content can include the operating system of the endpoint and any applications that are resident on the endpoint. Typically, executable content is stored in files on the endpoint. For example, executable content can be found in executable files (e.g., files of type “.EXE”), in dynamic link library files (e.g. files of type “.DLL”), and in other types of files, such as device drivers. The endpoint can execute the executable content as one or more processes. The executable content may have security holes or other exploitable vulnerabilities that can be remediated with a patch to the file storing the content.

The endpoint 102 includes a selective patching module 104 that selectively performs patching actions on executable content on the endpoint 102. A patching action can include, for example, notifying a user of the endpoint that a patch is available and/or initiating patching of executable content. In one embodiment, the selective patching module 104 monitors the usage of executable content on the endpoint 102 and calculates a usage score for the executable content. The usage score indicates how often the executable content is used (e.g., executed) at the endpoint 102. The selective patching module 104 also receives notifications from the security server 106 identifying patches that are available for particular executable content.

If a patch is available for executable content at the endpoint 102, the selective patching module 104 determines whether to perform a patching action based at least in part on the usage score for that content. In one embodiment, the selective patching modules 104 evaluates the usage score against a usage threshold, and performs the patching action based on the outcome of the comparison. For example, the usage threshold can signify the level of usage below which the executable content is determined to be “latent,” or infrequently used. Latent executable content is presumed safe to patch. Even if the newly-patched latent executable content is problematic, it is not likely to have a severe impact on the overall use of the endpoint 102 due to the low usage rate of the content. The selective patching module 104 thus balances the benefit of reducing the attack surface of the executable content via the patch against the risk of interfering with the operation of the endpoint, and initiates patching actions only if the benefit is judged to outweigh the risk.

The security server 106 communicates with the endpoints 102 to provide notifications of available patches to the selective patching module 104. In one embodiment, the security server 106 provides the endpoints 102 with patch definition files. Each patch definition file is associated with particular executable content and contains information describing the content and the patch. The selective patching modules 104 use the patch definition file entries to determine whether to perform patching actions on the endpoints 102.

In some embodiments, the security server 106 supplies information used by the endpoints 102 to establish the usage threshold. The security server 106 can provide the endpoints 102 with a global usage threshold applicable to all executable content. The security sever 106 can also provide the endpoints 102 with usage thresholds applicable to specific executable content or patches. For example, the security server 106 can set the usage threshold for a patch that remediates a particularly severe vulnerability so that the endpoints 102 are more likely to apply the patch. The security server 106 can supply the usage threshold information within the patch definition files or via a separate channel. Depending upon the embodiment, the security server 106 can be managed by an IT administrator of the enterprise in which the endpoints 102 are associated, and/or by a third party such as a security software provider.

The network 108 represents the communication pathways between the endpoints 102 and the server 106. In one embodiment, the network 108 is the Internet and uses standard communications technologies and/or protocols. Thus, the network 108 can include links using technologies such as Ethernet, 802.11, worldwide interoperability for microwave access (WiMAX), 3G, digital subscriber line (DSL), asynchronous transfer mode (ATM), InfiniBand, PCI Express Advanced Switching, etc. Similarly, the networking protocols used on the network 108 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc. The data exchanged over the network 108 can be represented using technologies and/or formats including the hypertext markup language (HTML), the extensible markup language (XML), etc. In addition, all or some of links can be encrypted using conventional encryption technologies such as secure sockets layer (SSL), transport layer security (TLS), virtual private networks (VPNs), Internet Protocol security (IPsec), etc. In another embodiment, the entities can use custom and/or dedicated data communications technologies instead of, or in addition to, the ones described above.

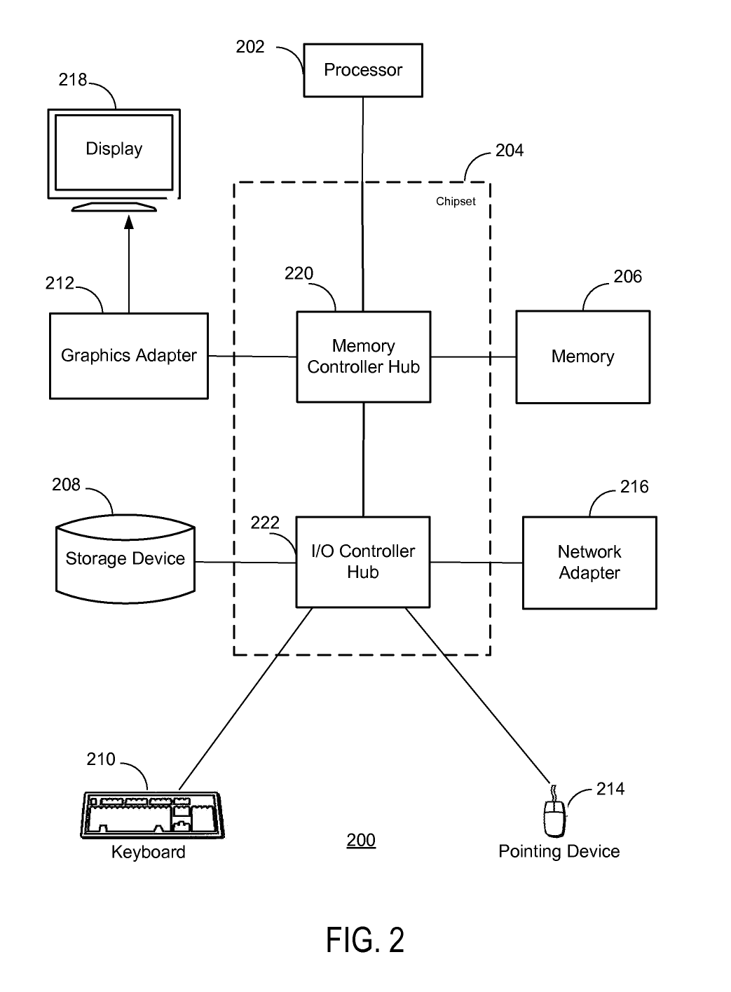

FIG. 2 is a high-level block diagram illustrating a typical computer 200 for use as an endpoint 102 or security server 106. Illustrated are at least one processor 202 coupled to a chipset 204. Also coupled to the chipset 204 are a memory 206, a storage device 208, a keyboard 210, a graphics adapter 212, a pointing device 214, and a network adapter 216. A display 218 is coupled to the graphics adapter 212. In one embodiment, the functionality of the chipset 204 is provided by a memory controller hub 220 and an I/O controller hub 222. In another embodiment, the memory 206 is coupled directly to the processor 202 instead of the chipset 204.

The memory 206 holds instructions and data used by the processor 202. The pointing device 214 may be a mouse, track ball, or other type of pointing device, and is used in combination with the keyboard 210 to input data into the computer system 200. The graphics adapter 212 displays images and other information on the display 218. The network adapter 216 couples the computer system 200 to a local or wide area network. The storage device 208 is any non-transitory computer-readable storage medium, such as a hard drive, compact disk read-only memory (CD-ROM), DVD, or a solid-state memory device. The storage device 208 holds executable content in one or more files.

As is known in the art, a computer 200 can have different and/or other components than those shown in FIG. 2. In addition, the computer 200 can lack certain illustrated components. In one embodiment, a computer 200 acting as a security server 106 lacks a keyboard 210, pointing device 214, graphics adapter 212, and/or display 218. Moreover, the storage device 208 can be local and/or remote from the computer 200 (such as embodied within a storage area network (SAN)).

This description utilizes the term “module” to refer to computer program logic for providing a specified functionality. A module can be implemented in hardware, firmware, and/or software. A module is typically stored on the storage device 208, loaded into the memory 206, and executed by the processor 202.

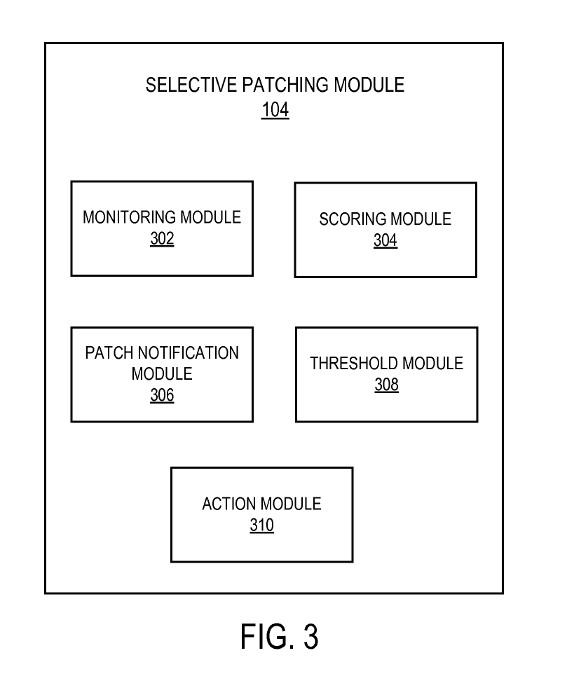

FIG. 3 is a high-level block diagram illustrating a detailed view of the selective patching module 104 according to one embodiment. In some embodiments the selective patching module 104 is incorporated into an operating system executing on the endpoint 102 while in other embodiments the selective patching module 104 is a standalone application or part of another product. As shown in FIG. 3, the selective patching module 104 itself includes multiple modules.

A monitoring module 302 monitors the endpoint 102 for the usage of executable content. In one embodiment, the monitoring module 302 interfaces with the operating system to identify when and what executable content is executing. The monitoring module 302 learns from the operating system when particular pieces of executable content start and stop executing. Executable content is considered to be “in use” during the period of time between when it starts executing (a “start event”) and when it stops executing (a “stop event”).

In one embodiment, the monitoring module 302 identifies start and stop events by registering for callbacks provided by the operating system. Certain operating systems, such as MICROSOFT WINDOWS, allow modules to register for notifications when certain events occur and the monitoring module 302 uses this functionality to register for start and stop events. Alternatively, for operating systems that do not support callbacks, the monitoring module 302 can patch the operating system to intercept calls and/or other behaviors that allow the monitoring module 302 to detect start and stop events. The monitoring module 302 saves the start and stop events, along with associated data such as the date and times on which the events occurred, for subsequent analysis.

In one embodiment, the monitoring module 302 monitors the usage of all executable content on the endpoint 102. In another embodiment, the monitoring module 302 monitors for usage of only certain executable content. For example, the monitoring module 302 may be configured to monitor, or not monitor, content on a list supplied by the security server 106. Similarly, the monitoring module 302 can be configured to monitor certain types of content, such as files of type .EXE and .DLL. The monitoring module 302 can also be configured to selectively monitor content based on the location for the content. For example, the monitoring module 302 can ignore executable content that is launched from directories designated to hold installers, patchers, and other transient tools.

The monitoring module 302 also monitors the uptime of the endpoint 102. “Uptime” refers to the amount of time during which the endpoint 102 is capable of running executable content, namely when the endpoint is powered on but not in a low-power mode such as “sleep” or “hibernate.” In one embodiment, the total uptime of the endpoint 102 can be broken down into individual periods of time, and the uptime can be recorded for each individual period. For example, the monitoring module 302 can record the total uptime of the endpoint 102 for each day over the past ninety days. Further, the uptime measurement can be an approximation instead of an exact measurement of the total uptime of the system. The monitoring module 302 stores the uptime measurements for subsequent analysis.

A scoring module 304 calculates a usage score for the executable content monitored by the monitoring module 302. A usage score indicates how often particular executable content is used on the endpoint 102 and is a function of the length of time during which the executable content is running and the total system uptime. In one embodiment, the usage score is determined by dividing the usage of particular executable content over a finite window of time by the total uptime of the system during the same window of time. Thus, the less often the executable content is used during the time window, the lower the usage score for that content. For example, using a scale of 0-1000, a usage score of 0 indicates that the executable content was not executed on the endpoint 102 during the time period. A usage score of 1000 indicates that the executable content was always executing while the endpoint was up. A usage score of 200 indicates that the executable content was executed 20% of the time that the endpoint was up.

In one embodiment, the usage score determined by the scoring module 304 decays over time. The decay places greater emphasis on usage that is recent, while de-emphasizing usage that occurred in the past. Thus, executable content that was run fairly often in the past will have a low usage score if it was not run recently. For example, the scoring module 304 may be configured so that the usage of executable content has a reduced effect on the usage score for each day that passes between the recorded usage and the current date.

A patch notification module 306 determines whether patches are available for updating executable content stored at the endpoint 102. In one embodiment, the patch notification module 306 communicates with the security server 106 and receives notifications of available patches. The patch notification module 306 can receive notifications of patches from the security server 106 on a periodic basis, upon request, and/or when patches are pushed by the security server. Likewise, the patch notification module 306 can inventory the executable content present on the endpoint 102 and query the security server 106 for patches available for that content.

As mentioned above, in one embodiment the patch notification module 306 receives patch definition files from the security server 106. A patch definition file contains entries identifying the executable content with which it is associated, the version of the executable content, the name of the updater responsible for the executable content, time stamps indicating when the entries were added to the definition file, etc. The patch notification module 306 compares the definition files to the executable content installed on the endpoint 102 to determine if the content can be patched.

If a patch is associated with executable content on the endpoint 102, a threshold module 308 determines whether to perform a patching action for the content. In one embodiment, the threshold module 308 determines the current usage score for the executable content and compares it to the usage threshold. As mentioned above, the usage threshold indicates the level of usage below which the executable content is considered latent. The usage threshold can be established by the user of the endpoint 102, an administrator of the security server 106, a field within a definition file, or other techniques. If the comparison of the usage score with the usage threshold indicates that the executable content is latent, an embodiment of the threshold module 308 concludes that a patching action should be performed for the content.

An action module 310 selectively performs a patching action on executable content at the endpoint 102. In one embodiment, the action module 310 is activated by the threshold module 308 if the comparison of the usage score for executable content and the applicable usage threshold indicates that the executable content is latent. The patching action performed by the action module 310 can vary in different embodiments and can be specified by the user of the endpoint 102, the administrator of the security server 106, and/or by another entity.

In one embodiment, the patching action involves launching the updater program responsible for the executable content. For example, the executable content may have a customized updater that is supplied by the same entity that provided the executable content. The updater, when executed, patches the executable content in a manner deemed optimal by the entity that provided the content. In one embodiment, the action module 310 records the fact that the updater was launched, and does not launch the updater again until the patch definition file indicates that a new vulnerability has been detected or a new patch is available.

In another embodiment, the patching action performed by the action module 310 presents the user of the endpoint 102 with a notification that a patch is available for the executable content. The action module 310 can also provide the user with several options, such as options to install the patch, not install the patch, or install the patch at a later time. If the user chooses to install the patch, the action module 310 launches the updater for the executable content. If the user chooses not to install the patch, the action module 310 does not launch the updating program and records the fact that the user chose not to install the patch.

In a further embodiment, the patching action performed by the action module 310 involves automatically installing the patch without asking for user input or launching the updater. For example, the action module 310 may download a self-installing patch from the security server 106 or elsewhere and automatically install the patch without notifying the user.

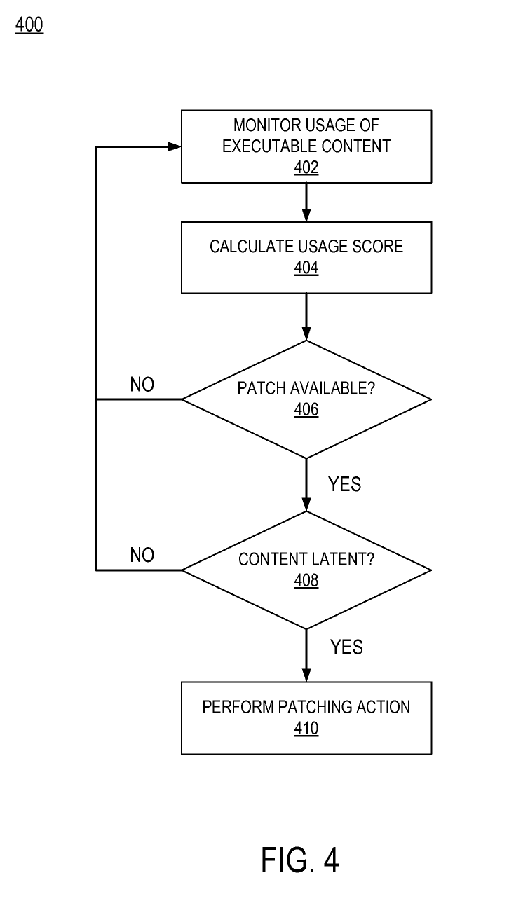

FIG. 4 is a flowchart 400 illustrating steps performed by the selective patching module 104 according to one embodiment. Other embodiments perform the illustrated steps in different orders, and/or perform different or additional steps. Moreover, some or all of the steps can be performed by modules other than the selective patching module 104. Further, one or more of the illustrated steps can be performed simultaneously by the selective patching module 104.

The selective patching module 104 continuously monitors 402 the usage of executable content present at the endpoint 102. The selective patching module 104 calculates 404 the usage score for a particular piece of executable content based on the usage of the executable content and the uptime of the endpoint 102. The selective patching module 104 further determines if a patch is available 406 for the executable content. If a patch is available, the selective patching module 104 compares the usage score with a usage threshold to determine whether the executable content is latent 408. If the content is latent, the selective patching module performs 410 a patching action. If either no patch is available or the content is not latent, no patching action is performed and the selective patching module 410 returns to monitor 402 the usage of the executable content.

The above description is included to illustrate the operation of the embodiments and is not meant to limit the scope of the invention. The scope of the invention is to be limited only by the following claims. From the above discussion, many variations will be apparent to one skilled in the relevant art that would yet be encompassed by the spirit and scope of the invention. As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

1. A method for selectively patching executable content on an endpoint comprising:
monitoring usage of the executable content on the endpoint;
calculating a usage score for the executable content based on the monitored usage, the usage score indicating how often the executable content is used at the endpoint;
determining whether to perform a patching action on the executable content responsive to the usage score; and
selectively performing the patching action based on the determination of whether to perform the patching action.

2. The method of claim 1, wherein calculating the usage score comprises:
identifying an amount of time the executable content is executing on the endpoint within a given time period;
identifying an uptime for the endpoint during the given time period; and
calculating the usage score for the executable content as a function of the length of time the executable content is executing and the uptime of the endpoint for the given time period.

3. The method of claim 1, wherein calculating the usage score comprises:
decaying the usage score over time to make the usage score indicate how often the executable content was recently used at the endpoint.

4. The method of claim 1, further comprising:
receiving a patch definition file from a security server, the patch definition file describing a patch available for the executable content; and
wherein the determining is performed responsive to receiving the patch definition file for the executable content.

5. The method of claim 1, wherein determining whether to perform a patching action comprises:
establishing a usage threshold for the executable content;
comparing the usage score to the usage threshold; and
determining whether the comparison indicates that the executable content is latent, wherein the patching action is performed if the executable content is latent.

6. The method of claim 5, wherein the usage threshold indicates an amount of usage below which executable content is considered latent, and wherein the executable content is latent if the usage score indicates that an amount of usage of the executable content is below the usage threshold.

7. The method of claim 1, wherein the patching action comprises at least one of the following actions:
notifying a user of the endpoint that a patch is available for the executable content;
launching an updater program for updating the executable content; and
patching the executable content.

8. A non-transitory computer-readable storage medium storing executable computer program instructions for selectively patching executable content on an endpoint, the computer program instructions comprising instructions for:
monitoring usage of the executable content on the endpoint;
calculating a usage score for the executable content based on the monitored usage, the usage score indicating how often the executable content is used at the endpoint;
determining whether to perform a patching action on the executable content responsive to the usage score; and
selectively performing the patching action based on the determination of whether to perform the patching action.

9. The computer-readable storage medium of claim 8, wherein calculating the usage score comprises:
identifying an amount of time the executable content is executing on the endpoint within a given time period;
identifying an uptime for the endpoint during the given time period; and
calculating the usage score for the executable content as a function of the length of time the executable content is executing and the uptime of the endpoint for the given time period.

10. The computer-readable storage medium of claim 8, wherein calculating the usage score comprises:
decaying the usage score over time to make the usage score indicate how often the executable content was recently used at the endpoint.

11. The computer-readable storage medium of claim 8, wherein the instructions further comprise instructions for:
receiving a patch definition file from a security server, the patch definition file describing a patch available for the executable content; and
wherein the determining is performed responsive to receiving the patch definition file for the executable content.

12. The computer-readable storage medium of claim 8, wherein determining whether to perform a patching action comprises:
establishing a usage threshold for the executable content;
comparing the usage score to the usage threshold; and
determining whether the comparison indicates that the executable content is latent, wherein the patching action is performed if the executable content is latent.

13. The computer-readable storage medium of claim 12, wherein the usage threshold indicates an amount of usage below which executable content is considered latent, and wherein the executable content is latent if the usage score indicates that an amount of usage of the executable content is below the usage threshold.

14. The computer-readable storage medium of claim 8, wherein the patching action comprises at least one of the following actions:
notifying a user of the endpoint that a patch is available for the executable content;
launching an updater program for updating the executable content; and
patching the executable content.

15. A system for selectively patching executable content on an endpoint, the system comprising:
a non-transitory computer-readable storage medium storing executable computer program instructions comprising instructions for:
monitoring usage of the executable content on the endpoint;
calculating a usage score for the executable content based on the monitored usage, the usage score indicating how often the executable content is used at the endpoint;
determining whether to perform a patching action on the executable content responsive to the usage score; and
selectively performing the patching action based on the determination of whether to perform the patching action; and
a processor for executing the computer program instructions.

16. The system of claim 15, wherein calculating the usage score comprises:
identifying an amount of time the executable content is executing on the endpoint within a given time period;
identifying an uptime for the endpoint during the given time period; and
calculating the usage score for the executable content as a function of the length of time the executable content is executing and the uptime of the endpoint for the given time period.

17. The system of claim 15, wherein calculating the usage score comprises:
decaying the usage score over time to make the usage score indicate how often the executable content was recently used at the endpoint.

18. The system of claim 15, wherein the instructions further comprise instructions for:
receiving a patch definition file from a security server, the patch definition file describing a patch available for the executable content; and
wherein the determining is performed responsive to receiving the patch definition file for the executable content.

19. The system of claim 15, wherein determining whether to perform a patching action comprises:
establishing a usage threshold for the executable content;
comparing the usage score to the usage threshold; and
determining whether the comparison indicates that the executable content is latent, wherein the patching action is performed if the executable content is latent.

20. The system of claim 19, wherein the usage threshold indicates an amount of usage below which executable content is considered latent, and wherein the executable content is latent if the usage score indicates that an amount of usage of the executable content is below the usage threshold.
